(19) United States
(12) Patent Application Publication
(10) Pub. No.: US 2014/0228058 A1
(43) Pub. Date: Aug. 14, 2014

(54) SYSTEM FOR ESTIMATING POSITION OF BASE STATION AND METHOD OF ESTIMATING POSITION OF BASE STATION BY THE SAME

(71) Applicant: Electronics and Telecommunications Research Institute, Daejeon (KR)

(72) Inventors: Myung In JI, Daejeon (KR); Young Su CHO, Seoul (KR); Joo Young KIM, Daejeon (KR); Yang Koo LEE, Cheongju (KR); Sang Joon PARK, Daejeon (KR)

(73) Assignee: Electronics and Telecommunications Research Institute, Daejeon (KR)

(21) Appl. No.: 14/089,665

(22) Filed: Nov. 25, 2013

(30) Foreign Application Priority Data
Feb. 14, 2013 (KR) 10-2013-0015749

(51) Int. Cl. G01S 5/00

(52) U.S. Cl. CPC G01S 5/0045
USPC 455/456.5

(57) ABSTRACT

According to the present invention, a system of estimating a position of a base station comprises a portable collecting device that considers a collection distribution for a plurality of base stations, arbitrarily sets positions of the plurality of base stations, and collects signal strengths transmitted from the plurality of arbitrarily set base stations and a server device that measures the signal strengths received from the portable collecting device, produces a signal attenuation pattern according to a distance between an arbitrarily set base station and the portable collecting device, and estimates a position of the base station according to an error between a signal strength estimated value at a specific point as estimated according to the signal attenuation pattern and an actually measured signal strength measured value at the specific point.

### CROSS-REFERENCE TO RELATED APPLICATIONS

This application claims the benefit of priority of Korean Patent Application No. 10-2013-0015749 filed on Feb. 14, 2013, all of which are incorporated by reference in their entirety herein.

### BACKGROUND OF THE INVENTION

1. Technical Field

The present invention relates to a system of estimating a position of a base station and a method of estimating a position of a base station by the same, and more specifically, a system of estimating a position of a base station that estimates the position of the base station for estimating a position of an indoor/outdoor terminal device and establishes a virtual fingerprint data base based on the estimated position of the base station and a method of estimating a position of a base station by the system.

2. Discussion of Related Art

There are various position estimating technologies using wireless communication infrastructures depending on the type of the infrastructure and service coverage. For example, the GNSS (Global Navigation Satellite System) refers to a system of determining the position of a user using signals emitted from satellites traveling along the earth orbit, and its similar systems, such as the U.S.'s GPS (Global Positioning System), Russia's GLONASS (Global Navigation Satellite System), and Europe's Galileo, are currently in operation or are scheduled for operation.

Such GNSS provides for high availability and positioning accuracy with an error range of 10 m on a flat ground or suburb area that secures the direct line of sight between a satellite unit and a receiving unit. In the non-line of sight, downtown area, however, its positioning error goes up to 50 m due to multi-path errors. In particular, just a few or no signals are received in the indoor area, thus making positioning difficult.

Among other wireless communication infra-technologies, a cellular-based position estimating technology pinpoints a user using the position information and measurement signals from a base station. Specifically, cellular-based position estimating technologies are classified into Cell-ID, E-OTD (Enhanced-Observed Time Difference), and AFLT (Advanced-Forward Link Trilateration) depending on the number of base stations from which signals may be received by a terminal device. In light of the characteristics of the mobile communication infrastructure of which the service coverage reaches most of the downtown and suburb areas, it may fulfill a locating operation not only outdoors but indoors as well. However, the cellular-based position estimating technologies have a degree of accuracy in position estimation that varies depending on the arrangement density of base stations. These technologies have a relatively low locating accuracy that ranges from about 100 to 800 m, on average, and are thus difficult to apply to indoor/outdoor navigation services that require a locating accuracy on the order of a few meters.

Assisted-GNSS means a technology that obtains assistant information from a position estimating server to reduce a time to first fix and to enhance the minimum receiving signal sensitivity of a GNSS receiver embedded in a user terminal device. The assisted-GNSS enables quick locating using the GNSS in the downtown area where receipt of signals is relatively low, but in the indoor area, it cannot work well due to too weak signals.

Next, the Wi-Fi-based position estimating technology is a representative one to address the difficulty of indoor position estimation. The Wi-Fi-based position estimating technology locates a terminal device using a database containing a reference position and identifiers of APs (base stations) and a measured value of a Wi-Fi AP received by the terminal device.

Meanwhile, a conventional prior document, Korean Patent Application Publication No. 10-2012-0038161, titled “system and method of estimating a position of a base station,” discloses estimating a position of a base station.

The above-referenced prior document suggests technical features including a wireless network quality measuring device that collects quality measurement data related with the quality of a wireless network from a base station and a base station position estimating device that selects an optimal PSC (Best primary Scrambling Code) at each measurement point using the quality measurement data of the wireless network quality measuring device, groups measurement points having the same optimal PSC, and then applies path loss models to the groups, respectively, thereby estimating a candidate position of the base station.

However, the base station position estimating scheme disclosed in the prior document measures a distance using the path loss models and applies it to, e.g., triangulation. Accordingly, it is difficult to create a database of positions of the base station together with performing accurate position estimation.

Further, the above-described Wi-Fi-based position estimating technologies have a limitation in expanding its Wi-Fi-based indoor locating to a broader range due to a lack of any organization of establishing a database of accurate positions or any standardized technology, as well as time and efforts that are consumed for precisely establishing a radio-map

### PRIOR ART DOCUMENT

### Patent Document

Korean Patent Application Publication No. 10-2012-0038161: system and method of estimating a position of a base station

### SUMMARY OF THE INVENTION

An object of the present invention is to provide a system of estimating a position of a base station that may estimate the position of the base station using data collected through a collecting device and a method of estimating the position of the base station by the system.

Another object of the present invention is to provide a system of estimating a position of a base station that may virtually establish a fingerprint database of positions of the base station together with estimating the position of the base station using data collected through a collecting device and a method of estimating the position of the base station by the system.

To achieve the objects, according to the present invention, a system of estimating a position of a base station comprises a portable collecting device that considers a collection distribution for a plurality of base stations, arbitrarily sets positions of the plurality of base stations, and collects signal strengths transmitted from the plurality of arbitrarily set base stations and a server device that measures the signal strengths received from the portable collecting device, produces a signal attenuation pattern according to a distance between an arbitrarily set base station and the portable collecting device, and estimates a position of the base station according to an error between a signal strength estimated value at a specific point as estimated according to the signal attenuation pattern and an actually measured signal strength measured value at the specific point.

Here, the server device may comprise a signal attenuation pattern producing unit that measures the signal strength received from the portable collecting device and produces the signal attenuation pattern according to the distance between the arbitrarily set base station and the portable collecting device and a position estimating unit that estimates the position of the base station according to the error between the signal strength estimated value at the specific point as estimated according to the signal attenuation pattern produced from the signal attenuation pattern producing unit and the actually measured signal strength measured value at the specific point.

Preferably, an algorithm for producing the signal attenuation pattern produced from the signal attenuation pattern producing unit may be represented in a following equation:

P_{Rx}_{ₖ}=\tilde{P}ₒ−10\tilde{α}log \tilde{dₖ} (dₒ=1 m,k,i are natural numbers)

wherein ( [symbol] , [symbol] ) is a position of the base station, \tilde{d}\tilde{dₖ} is a estimated distance between the base station and the portable collecting device, P_{Rx}_{ₖ} is the signal strength received by the portable collecting device, Pₒ is a unique value of the base station, and α is a signal attenuation index.

The signal attenuation pattern producing unit preferably resets the position of the base station to reproduce α when \tilde{P}ₒ of \tilde{P}ₒ and a produced and estimated in the equation of the algorithm departs from a reference Pₒ.

The algorithm for estimating the position of the base station from the position estimating unit may estimate [symbol] from \tilde{P}ₒ and \tilde{α} and may be represented in a following equation:

Diff_{BSi}=Σ₁^{k}| [symbol] −P_{Rx}_{ₖ}| [symbol] is a value estimated from \tilde{P}ₒ and \tilde{α}).

The estimated position of the base station estimated from the position estimating unit preferably uses a minimum value calculated from the equation of the algorithm of the position estimating unit.

Preferably, the server device may store the estimated position for the base station estimated from the position estimating unit in a position database.

The server device may further comprise a fingerprint establishing unit that produces signal strengths for ambient points of the estimated position of the base station using the estimated position of the base station and the signal attenuation pattern and stores a fingerprint in the database.

On the other hand, to achieve the above objects, according to the present invention, a method of estimating a position of a base station by a base station position estimating system comprises (a) setting a range of virtual positions for a plurality of base stations and setting virtual positions of the base stations, (b) producing a distance between the virtual positions of the base stations and a plurality of collection points spaced apart from the virtual positions of the base stations by receiving signal strengths at the plurality of collection points from the virtual positions of the base stations, (c) producing and estimating a unique value and a signal attenuation index of each of the base stations, (d) estimating a position of each of the base stations for each of the collection points, and (e) establishing a fingerprint database by producing signal strengths for ambient positions of the position of the base station estimated in step (d).

Here, step (c) may comprise determining whether the unique value and signal attenuation index of the estimated base station fits a reference range.

Step (c) may further comprise reproducing the unique value and signal attenuation index of the base station when the unique value and signal attenuation index of the estimated base station are determined to not fit the reference range.

In step (c), an algorithm for producing the unique value and signal attenuation index of the base station is preferably represented in a following equation:

P_{Rx}_{ₖ}=\tilde{P}ₒ−10\tilde{α}log \tilde{dₖ} (dₒ=1 m,k,i are natural numbers)

wherein ( [symbol] , [symbol] ) is a virtual position of the base station, \tilde{d}\tilde{dₖ} is an estimated distance between the base station and the collection point, P_{Rx}_{ₖ} is the signal strength received at the collection point, Pₒ is a unique value of the base station, and α is a signal attenuation index.

And, step (d) may comprise producing the estimated signal strength of each of the base stations using the unique value and the signal attenuation index of the estimated base station as produced in step (c) and estimating the position of the base station by calculating a sum or a difference between the estimated signal strength for each of the base stations and the signal strength actually received from the base station.

When in step (c), the position of the base station is reset to reproduce a when \tilde{p}\tilde{pₒ} of \tilde{p}\tilde{pₒ} and \tilde{α} produced and estimated in the equation of the algorithm departs from a reference Pₒ.

Preferably, in step (d), the algorithm for estimating the position of the base station may estimate [symbol] from \tilde{p}\tilde{pₒ} and \tilde{α} and may be represented in a following equation:

Diff_{BSi}=Σ₁^{k}| [symbol] −P_{Rx}_{ₖ}| [symbol] is a value estimated from \tilde{pₒ} and \tilde{α}).

The estimated position of the base station estimated in step (d) preferably uses a minimum value calculated from the equation of the algorithm of step (d).

Other embodiments are described in detail with the accompanying drawings.

According to the present invention, a system of estimating a position of a base station and a method of estimating the position of the base station by the system provide the following effects:

First, since the positions of base stations may be estimated based on information collected from a collecting device, the efficiency of the location-based technology may be increased.

Second, the positions of the base stations may be estimated, and signal strengths at ambient points of the positions of the base stations may be produced, so that a virtual database of a fingerprint may be established. Thus, the time and costs for establishing the database may be saved.

### BRIEF DESCRIPTION OF THE DRAWINGS

FIG. 1 is a control block diagram illustrating a base station position estimating system according to the present invention;

FIG. 2 is a view schematically illustrating a configuration of receiving a signal strength from each base station using a portable collecting device in a base station position estimating system according to the present invention;

FIGS. 3 and 4 are equations of algorithms for estimating a position of a base station by a base station position estimating method according to the present invention;

FIG. 5 is a control flowchart illustrating a base station position estimating method according to the present invention; and

FIG. 6 is a control flowchart illustrating a base station position estimating method according to the present invention, which establishes a fingerprint database.

### DESCRIPTION OF EMBODIMENTS

Hereinafter, a base station position estimating system and its base station position estimating method according to an embodiment of the present invention will be described in detail with reference to the accompanying drawings.

As used herein, the base station includes a Wi-Fi AP (Access Point) and a mobile communication base station that is positioned indoors and outdoors.

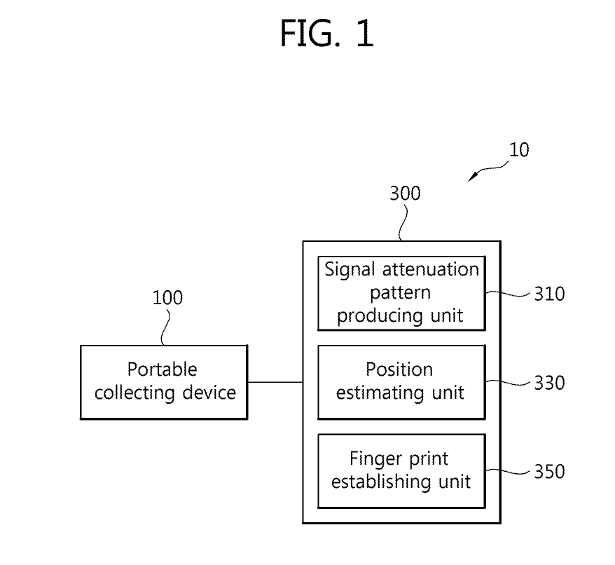

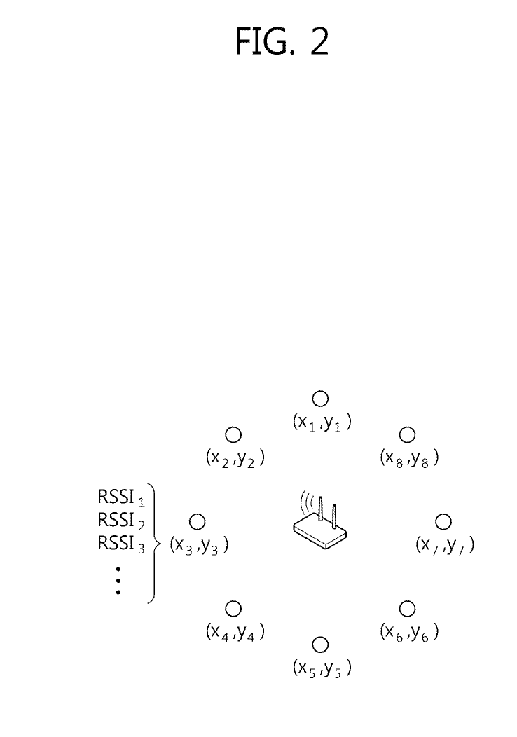

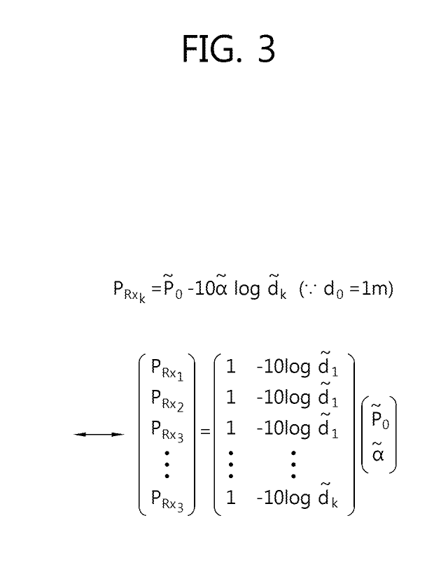

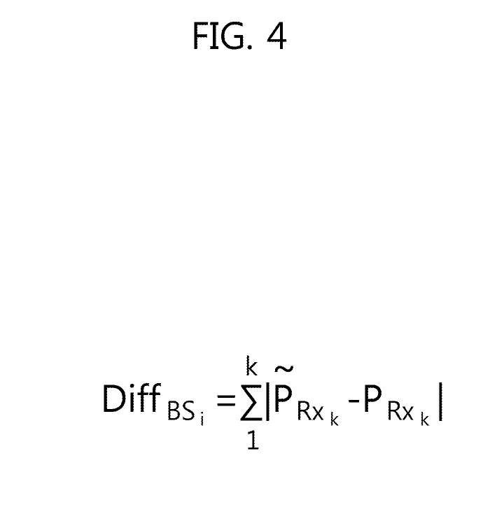

FIG. 1 is a control block diagram illustrating a base station position estimating system according to the present invention. FIG. 2 is a view schematically illustrating a configuration of receiving a signal strength from each base station using a portable collecting device in a base station position estimating system according to the present invention. FIGS. 3 and 4 are equations of algorithms for estimating a position of a base station by a base station position estimating method according to the present invention.

As shown in FIGS. 1 to 4, the base station position estimating system 10 according to the present invention includes a portable collecting device 100 and a server device 300.

The portable collecting device 100 considers a collection distribution for a plurality of base stations and arbitrarily configures positions of the plurality of base stations and collects signal strengths (RSSIs: received signal strength indications) transmitted from the plurality of arbitrarily set base stations. Here, the signal strengths collected by the portable collecting device 100 are primarily expressed in dBm, and collection points (collection positions) consist primarily of, in the case of outdoor, latitudes and longitudes, and in the case of indoor, latitudes and longitudes or relative coordinates with respect to a building reference point.

Next, the server device 300 produces a signal attenuation pattern according to a distance between the portable collecting device 100 and an arbitrarily set base station by measuring a signal strength received by the portable collecting device 100. Further, the server device 300 estimates the position of the base station according to an error between a signal strength actually measured at a specific point and an estimated value of the signal strength at the specific point as estimated according to the signal attenuation pattern. The server device 300 may not only store an estimated position of a base station estimated by a location estimating unit 330 to be described later in a database but may also store fingerprints in the database by producing the signal strengths for ambient points of the position of the estimated base station using the signal attenuation pattern and estimated position of the base station.

The server device 300, according to an embodiment of the present invention, includes a signal attenuation pattern producing unit 310, a location estimating unit 330, and a finger print establishing unit 350.

The signal attenuation pattern producing unit 310 measures a signal strength received from the portable collecting device 100 and produces a signal attenuation pattern according to a distance between the portable collecting device 100 and an arbitrarily set base station.

Here, the signal attenuation pattern producing unit 310 produces the signal attenuation pattern using the equation of the algorithm shown in FIG. 3. The signal attenuation pattern producing unit 310 produces the signal attenuation pattern by the following <Equation 1>:

P_{Rx}_{ₖ}=\tilde{P}ₒ−10\tilde{α}log \tilde{dₖ} (dₒ=1 m,k,i are natural numbers) <Equation 1>

where, ( [symbol] , [symbol] ) is a position of the base station, \tilde{d}\tilde{dₖ} is an estimated distance between the portable collecting device 100 and the base station, P_{Rx}_{ₖ} is a signal strength received by the portable collecting device 100, Pₒ is a unique value of the base station, and α is a signal attenuation index.

According to <Equation 1> above, the unique value Pₒ of the base station and the signal attenuation index α are produced.

The signal attenuation pattern producing unit 310, when \tilde{p}\tilde{pₒ} of \tilde{p}\tilde{pₒ} and \tilde{α} produced and estimated in <Equation 1> departs from a reference Pₒ range, resets the arbitrary position of the base station and reproduces a. For example, in case a large gap exists between Pₒ and the reference Pₒ or when the range of the general signal attenuation index α is off a lot, it is reproduced. In case a big difference is shown between Pₒ and reference Pₒ or when the range of the general signal attenuation index α is off a lot, this represents that there is an error in the relative coordinate ( [symbol] , [symbol] ) of the virtual position.

Meanwhile, the signal attenuation pattern producing unit 310 signal attenuation patterns for a plurality of base stations set to have virtual positions according to a Gaussian distribution as shown in FIG. 3.

The location estimating unit 330 estimates the position of the base station according to the error between the signal strength measured value actually measured at the specific point and the signal strength estimated value at the specific pint as estimated according to the signal attenuation pattern produced from the signal attenuation pattern producing unit 310. The location estimating unit 330 obtains a signal strength [symbol] inversely estimated using Pₒ and a estimated for the position of the base station estimated with reasonable values of Pₒ and a produced and estimated from the signal attenuation pattern producing unit 310. As such, using the algorithm shown in FIG. 4 using [symbol] , the position of the base station is estimated.

At this time, the coordinate ( [symbol] , [symbol] ) of the relative position of the base station corresponding to the minimum value among the values produced from the equation of the algorithm of the location estimating unit 330 is estimated as the position of the base station. With the minimum value produced using the equation of the algorithm of the location estimating unit 330, the Pₒ and a values may be interpreted as being closest to actually collected results. In other words, as the collection points of the portable collecting device 100 are evenly dispersed around the base station, better performance may be obtained. However, in some cases, the position of the base station may be estimated with, e.g., the maximum Pₒ point and the maximum a point.

Next, the finger print establishing unit 350 produces signal strengths for ambient points of the estimated position of the base station using the signal attenuation pattern and the estimated position of the base station and virtually stores and establishes a fingerprint database. Subsequently, the finger print establishing unit 350 virtually establishes a propagation fingerprint database for ambient regions of the base station.

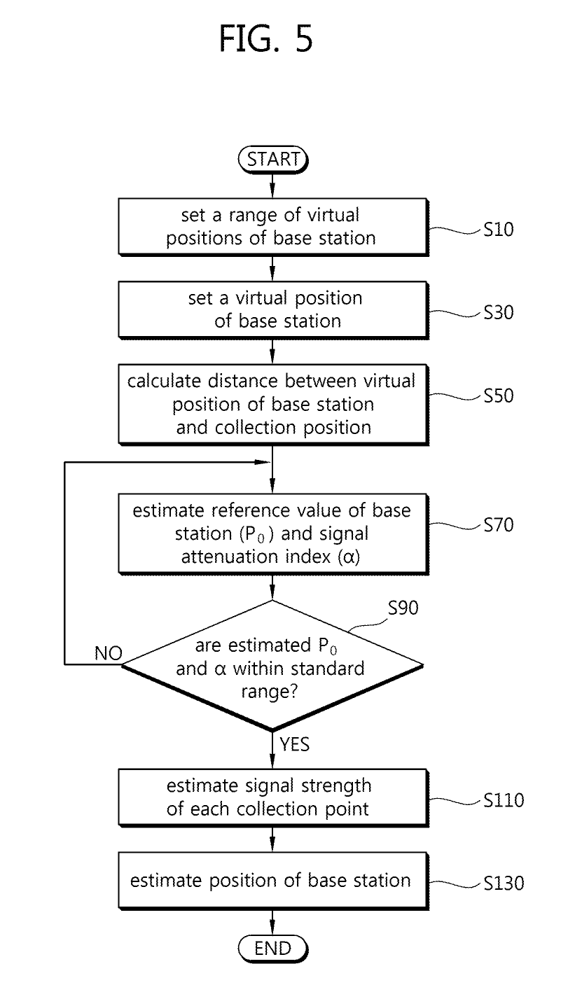

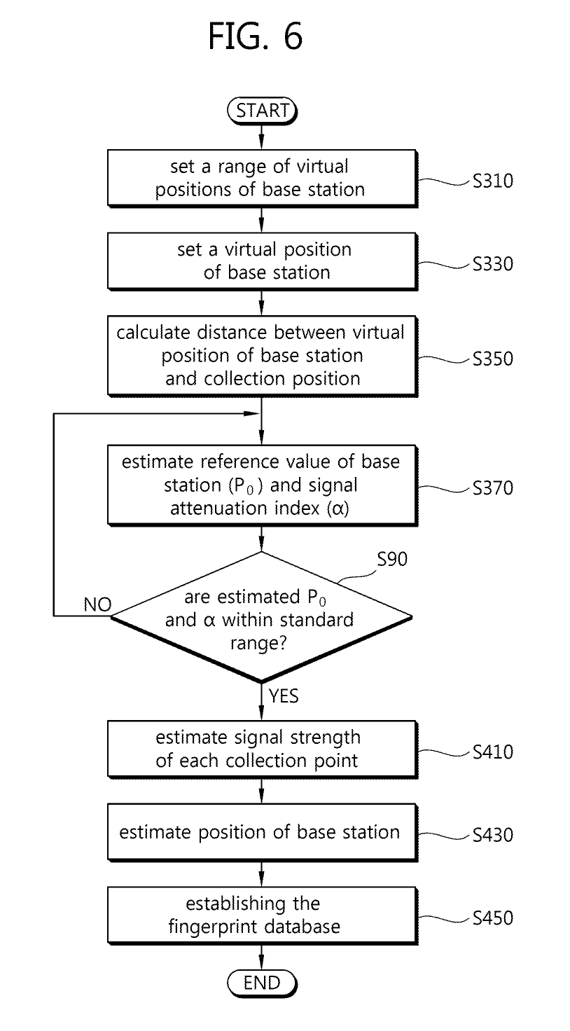

FIG. 5 is a control flowchart illustrating a base station position estimating method according to the present invention, and FIG. 6 is a control flowchart illustrating a base station position estimating method according to the present invention, which establishes a fingerprint database.

As shown in FIG. 5, the base station position estimating method is as follows.

First, a range of virtual positions for a plurality of base stations is set (S10). Virtual positions for the plurality of base stations in the virtual range are set (S30). Signal strengths are received from a plurality of collection points spaced apart from the virtual positions of the plurality of base stations, and distances between the virtual positions of the base stations and the collection points are obtained (S50). A base station reference value Pₒ and signal attenuation index α are produced and estimated (S70).

Whether Pₒ and α produced and estimated by the signal attenuation pattern producing unit 310 are within a reference range is determined (S90). If in step S90 the estimated Pₒ and α are determined to be within the reference range, the signal strength of each collection point is estimated (S110). And, the position of the base station is estimated (S130). In contrast, when in step S90 the estimated Pₒ and α are off a lot from the reference range, the base station reference value Pₒ and the signal attenuation index α are reproduced in step S70.

Lastly, in the control flowchart of a base station position estimating method shown in FIG. 6, a fingerprint database is virtually established in the base station position estimating method shown in FIG. 5.

First, a range of virtual positions for a plurality of base stations are set (S310). Virtual positions for the plurality of base stations in the virtual range are set (S330).

Signal strengths are received from the plurality of collection points spaced apart from the virtual positions of the base stations, and distances between the virtual positions of the base stations and the collection points are obtained (S350). A base station reference value Pₒ and a signal attenuation index α are produced and estimated (S370).

Whether the Pₒ and α produced and estimated by the signal attenuation pattern producing unit 310 are within a reference range is determined (S390). If in step S390 the estimated Pₒ and α and determined to be within the reference range, the signal strength of each collection point is estimated (S410). And, the position of the base station is estimated (S430). On the contrary, when in the S390 the estimated Pₒ and α are off a lot from the reference range, the base station reference value Pₒ and the signal attenuation index α are reproduced in step S370.

If the position of the base station is estimated in step S430, the signal strengths of the ambient points of the estimated position of the base station are produced using the estimated position of the base station and are stored in a fingerprint database, thereby establishing the fingerprint database (S450).

It will be understood by those skilled in the art that various changes may be made to the present invention without departing from the scope of the present invention, and accordingly, the present invention is not limited to the above-described embodiments and the accompanying drawings.

What is claimed is:

1. A system of estimating a position of a base station, the base station comprising:
a portable collecting device that considers a collection distribution for a plurality of base stations, arbitrarily sets positions of the plurality of base stations, and collects signal strengths transmitted from the plurality of arbitrarily set base stations; and
a server device that measures the signal strengths received from the portable collecting device, produces a signal attenuation pattern according to a distance between an arbitrarily set base station and the portable collecting device, and estimates a position of the base station according to an error between a signal strength estimated value at a specific point as estimated according to the signal attenuation pattern and an actually measured signal strength measured value at the specific point.

2. The system of claim 1, wherein the server device comprises:
a signal attenuation pattern producing unit that measures the signal strength received from the portable collecting device and produces the signal attenuation pattern according to the distance between the arbitrarily set base station and the portable collecting device; and
a position estimating unit that estimates the position of the base station according to the error between the signal strength estimated value at the specific point as estimated according to the signal attenuation pattern produced from the signal attenuation pattern producing unit and the actually measured signal strength measured value at the specific point.

3. The system of claim 2, wherein an algorithm for producing the signal attenuation pattern produced from the signal attenuation pattern producing unit is represented in a following equation:
P_{Rx}_{ₖ}=\tilde{P}ₒ−10\tilde{α}log \tilde{d}\tilde{dₖ} (dₒ=1 m,k,i are natural numbers)
wherein ( [symbol] , [symbol] ) is a position of the base station, \tilde{d}\tilde{dₖ} is a estimated distance between the base station and the portable collecting device, P_{Rx}_{ₖ} is the signal strength received by the portable collecting device, Pₒ is a unique value of the base station, and α is a signal attenuation index.

4. The system of claim 3, wherein the signal attenuation pattern producing unit resets the position of the base station to reproduce α when \tilde{P}ₒ of \tilde{P}ₒ and α produced and estimated in the equation of the algorithm departs from a reference Pₒ.

5. The system of claim 3, wherein the algorithm for estimating the position of the base station from the position estimating unit estimates [symbol] from \tilde{P}ₒ and \tilde{α} and is represented in a following equation:
Diff_{BSi}=Σ₁^{k}| [symbol] −P_{Rx}_{ₖ}|( [symbol] is a value estimated from \tilde{P}ₒ and \tilde{α}).

6. The system of claim 5, wherein the estimated position of the base station estimated from the position estimating unit uses a minimum value calculated from the equation of the algorithm of the position estimating unit.

7. The system of claim 2, wherein the server device stores the estimated position for the base station estimated from the position estimating unit in a position database.

8. The system of claim 7, wherein the server device further comprises a fingerprint establishing unit that produces signal strengths for ambient points of the estimated position of the base station using the estimated position of the base station and the signal attenuation pattern and stores a fingerprint in the database.

9. A method of estimating a position of a base station by a base station position estimating system, the method comprising:
(a) setting a range of virtual positions for a plurality of base stations and setting virtual positions of the base stations;
(b) producing a distance between the virtual positions of the base stations and a plurality of collection points spaced apart from the virtual positions of the base stations by receiving signal strengths at the plurality of collection points from the virtual positions of the base stations;
(c) producing and estimating a unique value and a signal attenuation index of each of the base stations;
(d) estimating a position of each of the base stations for each of the collection points; and
(e) establishing a fingerprint database by producing signal strengths for ambient positions of the position of the base station estimated in step (d).

10. The method of claim 9, wherein step (c) comprises determining whether the unique value and signal attenuation index of the estimated base station fits a reference range.

11. The method of claim 10, wherein step (c) further comprises reproducing the unique value and signal attenuation index of the base station when the unique value and signal attenuation index of the estimated base station are determined to not fit the reference range.

12. The method of claim 10, wherein in step (c), an algorithm for producing the unique value and signal attenuation index of the base station is represented in a following equation:
P_{Rx}_{ₖ}=\tilde{P}ₒ−10\tilde{α}log \tilde{dₖ} (dₒ=1 m,k,i are natural numbers)
wherein ( [symbol] , [symbol] ) is a virtual position of the base station, \tilde{d}\tilde{dₖ} is an estimated distance between the base station and the collection point, P_{Rx}_{ₖ} is the signal strength received at the collection point, Pₒ is a unique value of the base station, and α is a signal attenuation index.

13. The method of claim 12, wherein step (d) comprises:
producing the estimated signal strength of each of the base stations using the unique value and the signal attenuation index of the estimated base station as produced in step (c);
estimating the position of the base station by calculating a sum or a difference between the estimated signal strength for each of the base stations and the signal strength actually received from the base station.

14. The method of claim 13, wherein when in step (c), the position of the base station is reset to reproduce α when \tilde{p}\tilde{pₒ} of \tilde{p}\tilde{pₒ} and \tilde{α} produced and estimated in the equation of the algorithm departs from a reference Pₒ.

15. The method of claim 14, wherein in step (d), the algorithm for estimating the position of the base station estimates [symbol] from \tilde{p}\tilde{pₒ} and \tilde{α} and is represented in a following equation:
Diff_{BSi}=Σ₁^{k}| [symbol] −P_{Rx}_{ₖ}|( [symbol] is a value estimated from \tilde{p}\tilde{pₒ} and \tilde{α}).

16. The method of claim 15, wherein the estimated position of the base station estimated in step (d) uses a minimum value calculated from the equation of the algorithm of step (d).
